(19) United States
(12) Patent Application Publication
(10) Pub. No.: US 2012/0278409 A1
(43) Pub. Date: Nov. 1, 2012

(54) MAIL SYSTEM

(75) Inventors: Masafumi Kinoshita, Sagamihara (JP); Toshiyuki Kamiya, Yokohama (JP); Takafumi Koike, Kawasaki (JP)

(73) Assignee: HITACHI, LTD., Tokyo (JP)

(21) Appl. No.: 13/398,938

(22) Filed: Feb. 17, 2012

(30) Foreign Application Priority Data
Apr. 28, 2011 (JP) 2011-101219

(51) Int. Cl. G06F 15/16

(52) U.S. Cl. 709/206

(57) ABSTRACT

A mail system includes: a data store server that stores a mail transmitted to a user of a terminal device; a mailbox server that controls the storage of the mail. A storage part of the data store server has a first storage part and a second storage part. A control part of the mailbox server determines whether a mail is stored in the first storage part or in the second storage part, based on at least one of a feature of the mail, a feature of the storage part of the data store server, and setting information.

### CROSS REFERENCE TO RELATED APPLICATION

This application claims the benefit of Japanese Patent Application No. 2011-101219 filed on Apr. 28, 2011, the disclosure of which is incorporated herein by reference.

### BACKGROUND

A subject matter disclosed herein relates to a mail system.

Along with a wide-spread use of mail services on cell phones, a mail system of a company which provides cell phones or mobile data terminals with data communication services (to be hereinafter referred to as a mobile communication carrier) processes a large number of mails.

An outline of such a mail system of a mobile communication carrier is described below.

A mobile communication carrier has a mailbox server in which a mail of a subscriber to the carrier for mail service is stored. The mailbox server stores a received mail in a storage unit (to be hereinafter referred to as a disk) such as a magnetic disk drive.

Upon receipt of a mail acquisition request from a cell phone or the like of the mail service subscriber, the mailbox server acquires a mail corresponding to the request from the disk and transmits the acquired mail to the cell phone or the like.

In the mail system of a mobile communication carrier, as described above, the number of processable mails per unit time (to be hereinafter referred to as a throughput) so far depends on a processing speed of a disk (disk input/output performance).

A technique described in a patent document as below has been known as a technique for efficiently managing a mail.

Japanese Laid-Open Patent Application, Publication No. 2002-359649 (paragraphs [0008], [0021], and the like) discloses a mail server which determines whether or not a mail is accessed by an electronic device with high possibility, based on access histories by taking into account characteristic access operations by users. A mail determined to have a high possibility of being accessed is stored in a memory. Meanwhile, a mail determined not to have a high possibility of being accessed is stored in a hard disk.

A low-capacity memory can perform high-speed processing, but is expensive. A high-capacity hard disk cannot perform high-speed processing, but is low-priced. Which of the two is used is determined according to the access history, thus enabling an efficient mail management.

### SUMMARY

The technique disclosed in Japanese Laid-Open Patent Application, Publication No. 2002-359649, however, does not describe a determination of where to store a mail based on features of a mail and a mailbox. Rather, the technique describes the determination based on the access history of a mail by an electronic device.

This Specification discloses a mail system in which, by determining a mail storage destination based on features of a mail and a mailbox, the mail is efficiently managed and a mail throughput is improved.

To solve the problems as described above, the mail system disclosed herein includes: a data store server that stores therein a mail transmitted to a user of a terminal device; and a mailbox server that controls the storage of the mail. A storage part of the data store server has a first storage part and a second storage part. A control part of the mailbox server determines whether the mail is stored in the first storage part or in the second storage part, based on at least one of a feature of the mail, a feature of the control part of the data store server, and information on setting of the terminal device.

The disclosure herein can provide a mail system in which a mail throughput is improved.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a configuration example of a schematic block diagram illustrating an embodiment.

FIG. 2A and FIG. 2B are diagrams illustrating a configuration example of a mailbox server according to the embodiment. FIG. 2A is a diagram illustrating an outline of the configuration example of the mailbox server. FIG. 2B is a diagram illustrating a configuration example of a volatile storage part.

FIG. 3A to FIG. 3D are diagrams illustrating a configuration example of a data store server according to the embodiment. FIG. 3A is a diagram illustrating an outline of the configuration example of the data store server. FIG. 3B is a diagram illustrating a configuration example of a volatile storage part. FIG. 3C is a diagram illustrating a configuration example of mail data information. FIG. 3D is a diagram illustrating a configuration example of mailbox management information stored in an entry data.

FIG. 4 is a diagram illustrating a configuration example of a data transferred between the mailbox server and the data store server according to the embodiment.

FIG. 5 is a sequence diagram illustrating an example of a mail storage processing according to the embodiment.

FIG. 6 is a sequence diagram illustrating an example of a mail receipt processing in a case in which a communication terminal automatically acquires a mail according to the embodiment.

FIG. 7 is a sequence diagram illustrating an example of a mail receipt processing in a case in which a user of a communication terminal operates the communication terminal to thereby acquire a mail according to the embodiment.

FIG. 8 is a flowchart of an example of a mail storage destination determination processing according to the embodiment.

### DETAILED DESCRIPTION OF THE EXEMPLARY EMBODIMENT

Next is described in detail an embodiment of the disclosed mail system with reference to related drawings. In all of the related drawings for describing this embodiment, the same reference numerals are basically given to similar components, and a duplicate description of those components is omitted here from.

### <Configuration>

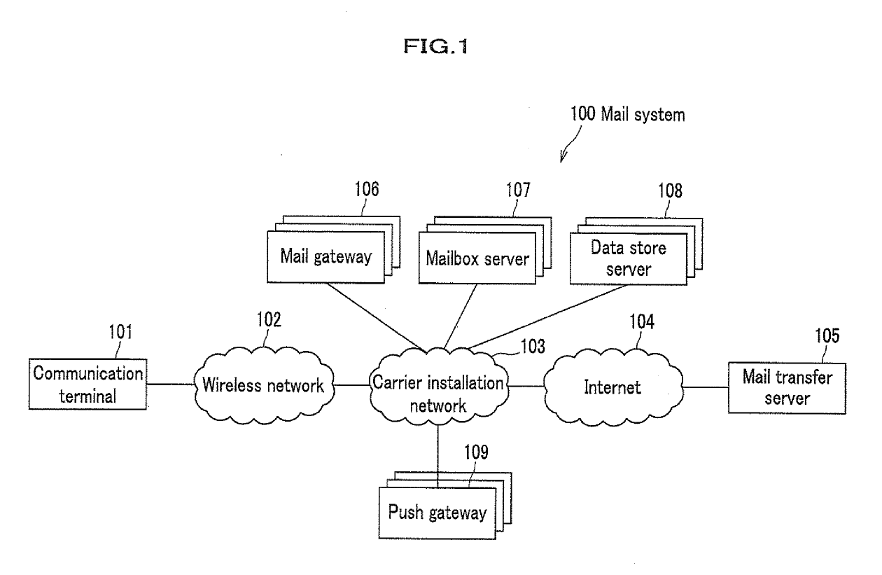

FIG. 1 a schematic block diagram illustrating this embodiment.

A mail system 100 includes a communication terminal 101, a wireless network 102, a carrier installation network 103, the Internet 104, a mail transfer server 105, a mail gateway 106, a mailbox server 107, a data store server 108, and a push gateway 109.

The communication terminal 101 is a data communicable terminal device. The communication terminal 101 is, for example, a cell phone, a mobile data terminal, a personal computer, or the like.

The wireless network 102 is a network which performs wireless communications.

The carrier installation network 103 is a network and networking equipment which relays communications from the wireless network 102 to the Internet 104 and the mail gateway 106 to be described hereinafter.

The Internet 104 is a network utilizing a technique of the Internet Protocol.

The mail transfer server 105, also called a MTA (Mail Transfer Agent), is a device which transmits and receives a mail to and from the mail gateway 106 to be described later, via the Internet 104.

The mail gateway 106 is a device which performs a processing of relaying a mail received via the mail transfer server 105, to the mailbox server 107 to be described later. The mail gateway 106 also performs a processing of transmitting a request of transmitting a message for acknowledging a receipt of the mail (to be hereinafter referred to as a mail receipt acknowledgement) to the communication terminal 101 via the push gateway 109 to be described hereinafter, and a processing of relaying a mail acquisition request from the communication terminal 101 to the mailbox server 107.

Typically, one of SMTP (Simple Mail Transfer Protocol), ESMTP (Extended SMTP), IMAP (Internet Message Access Protocol), and MMS (Multimedia Messaging Service) is used for communication protocols between the mail gateway 106 and the communication terminal 101 and between the mail gateway 106 and the mail transfer server 105. In this embodiment, techniques used for the communication protocols are not limited, and any techniques can be used.

In this embodiment, description is made assuming a case, as an example, in which a mail is delivered in order of the mail transfer server 105, the mail gateway 106, and the mailbox server 107. However, the mail delivery route is not limited to this and may be in order of the communication terminal 101, the mail gateway 106, and the mailbox server 107.

The mailbox server 107 is a device performing a processing of storing and acquiring a mail between itself and the data store server 108 to be described later. The mailbox server 107 performs a processing of storing a mail received via the mail gateway 106 in a mailbox of a user. A communication protocol used at this time is generally IMAP or MMS.

The mailbox server 107 performs a processing of acquiring a mail from a mailbox of a user in response to a mail acquisition request from the communication terminal 101 and transmitting the mail to the communication terminal 101. A communication protocol used at this time is generally LMTP (Local Mail Transfer Protocol).

In this embodiment, however, the communication protocol used herein is not limited.

The data store server 108 is a device which performs a processing of receiving a mail from the mailbox server 107 and a data such as mailbox information to be described later, and stores the received data to a volatile memory or a disk. The data store server 108 also performs a processing of transmitting a response, in response to a mail acquisition request from the communication terminal 101 via the mailbox server 107. The data store server 108 is a data store which is generally called a key value store and manages a data by using a key and a value in pair.

The push gateway 109 is a device which performs a processing of receiving a mail receipt acknowledgement request from the mail gateway 106 and transmitting a mail receipt acknowledgement to the communication terminal 101. Herein, PAP (Push Access Protocol) is generally used for a protocol between the push gateway 109 and the mail gateway 106. SMPP (Short Message Peer-to-Peer Protocol) is generally used for a protocol between the push gateway 109 and the communication terminal 101. In this embodiment, however, a communication protocol used is not limited.

A plurality of any of the mail gateways 106, the mailbox servers 107, the data store servers 108, and the push gateways 109 may be used so as to share load thereon.

### <Mail Box Server>

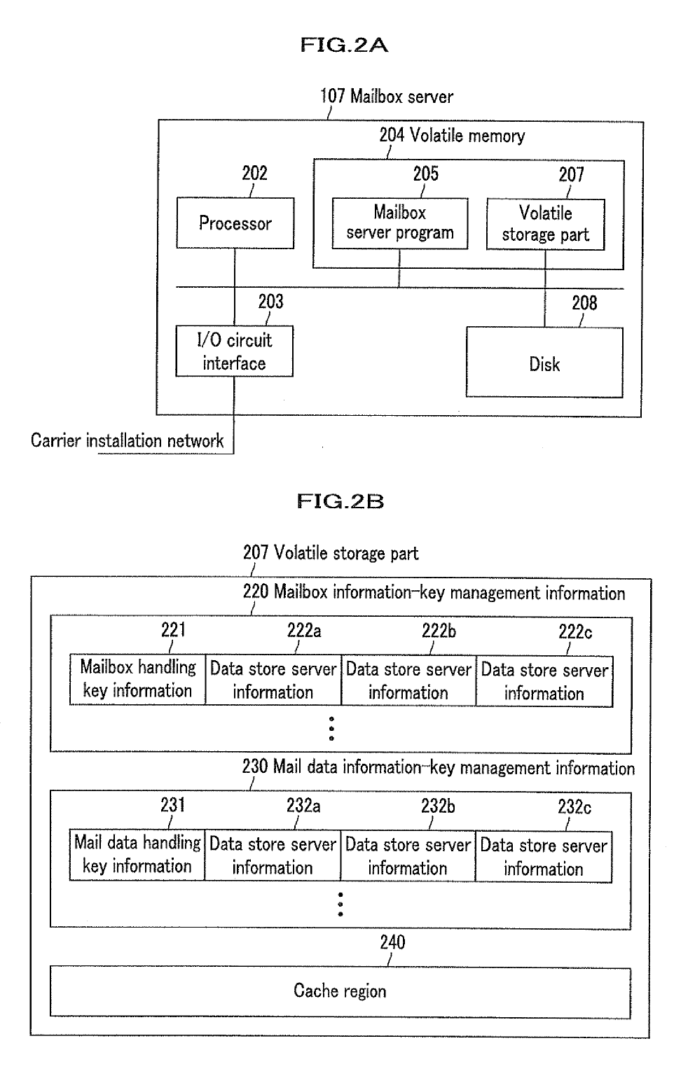

FIG. 2A and FIG. 2B are diagrams illustrating a configuration of the mailbox server 107 according to this embodiment. FIG. 2A is a diagram illustrating an outline of the configuration of the mailbox server 107 according to this embodiment.

The mailbox server 107 includes a processor 202, an I/O (input and output) circuit interface 203, a volatile memory 204, and a disk 208. Those components are coupled with each other via a bus.

The processor 202 executes a mailbox server program 205 stored in the volatile memory 204 to be described later and controls the mailbox server 107.

The I/O circuit interface 203 mediates transfer of information with an I/O circuit interface of other device.

The volatile memory 204 stores therein a data or a program for execution used by the mailbox server 107. The volatile memory 204 includes the mailbox server program 205 and a volatile storage part 207.

The mailbox server program 205 stores therein various programs for controlling the mailbox server 107 (to be described in detail hereinafter). Those programs may be loaded in the mailbox server program 205 via a detachable storage medium or a communication medium (a network, a digital signal, a carrier wave, or the like) both not shown.

The volatile storage part 207 stores therein mailbox information-key management information 220, mail data information-key management information 230, and a cache region 240, which are shown in FIG. 2B to be described hereinafter. The mailbox information-key management information 220 and the mail data information-key management information 230 have similar data configuration but store therein different information from each other (to be described in detail hereinafter).

The disk 208 stores therein a data such as a log outputted from the mailbox server program 205.

FIG. 2B is a diagram illustrating a configuration of the volatile storage part 207.

The mailbox information-key management information 220 is information which manages a key for identifying information on a mailbox stored in the data store server 108 (to be referred to as mailbox information hereinafter). The mailbox information-key management information 220 is referenced when the mailbox server 107 accesses the data store server 108 (to be described in detail hereinafter).

The mailbox information-key management information 220 includes mailbox handling key information 221 and data store server information 222 (which may be individually referred to as data store server information 222a, 222b, and 222c). The mailbox information-key management information 220 stores therein a plurality of pairs made up of the mailbox handling key information 221 and the data store server information 222.

The mailbox handling key information 221 is a value of a key for identifying mailbox information stored in the data store server 108. In other words, the mailbox handling key information 221 is a value of a key handled by the data store server 108. The mailbox handling key information 221 may store therein a plurality of keys by, for example, specifying an appropriate range.

The data store server information 222 is information for identifying the data store server 108 which stores therein mailbox information. The data store server 108 stores therein the mailbox information which is associated with a key identified by the mailbox handling key information 221 paired with the data store server information 222.

The data store server information 222 store therein, for example, an IP (Internet Protocol) address of the data store server 108.

As shown in FIG. 2B, the mailbox information-key management information 220 may be configured to include a plurality pieces of the data store server information 222a to 222c with respect to a single piece of the mailbox handling key information 221. For example, as a backup of the data store server 108 specified by the data store server information 222a, the data store server information 222b and the data store server information 222c may also specify the data store server 108.

The mail data information-key management information 230 is information which manages a key for identifying information on a mail stored in the data store server 108 (to be referred to as mail data information hereinafter). The mail data information-key management information 230 is referenced when the mailbox server 107 accesses the data store server 108 (to be described in detail hereinafter).

The mail data information-key management information 230 includes mail data handling key information 231 and data store server information 232 (which may be individually referred to as data store server information 232a, 232b, and 232c). The mail data information-key management information 230 stores therein a plurality of pairs made up of the mail data handling key information 231 and the data store server information 232.

The mail data handling key information 231 is a value of a key for identifying mailbox information stored in the data store server 108. In other words, the mail data handling key information 231 is a value of a key handled by the data store server 108. The mail data handling key information 231 may store therein a plurality of keys by, for example, specifying an appropriate range.

The data store server information 232 is information which identifies the data store server 108 for storing mail data information. The data store server 108 stores therein mail data information which is associated with a key identified by the mail data handling key information 231 paired with the data store server information 232.

The data store server information 232 stores therein, for example, an IP (Internet Protocol) stored in the address data store server 108.

As shown in FIG. 2B, the mail data information-key management information 230 may also be configured to include a plurality pieces of the data store server information 232a to 232c with respect to a single piece of the mail data handling key information 231. For example, as a backup of the data store server 108 specified by the data store server information 232a, the data store server information 232b and/or the data store server information 232c may also specify the data store server 108. Note that, in FIG. 2B, the mail data information-key management information 230 includes three pieces of the data store server information 232 (232a to 232c). However, the number of pieces is not limited to this.

The cache region 240 temporarily stores therein a data which the mailbox server program 205 uses for performing a processing. The cache region 240 stores therein, for example, a received mail, and mailbox information and mail data information acquired from the data store server 108.

### <Data Store Server>

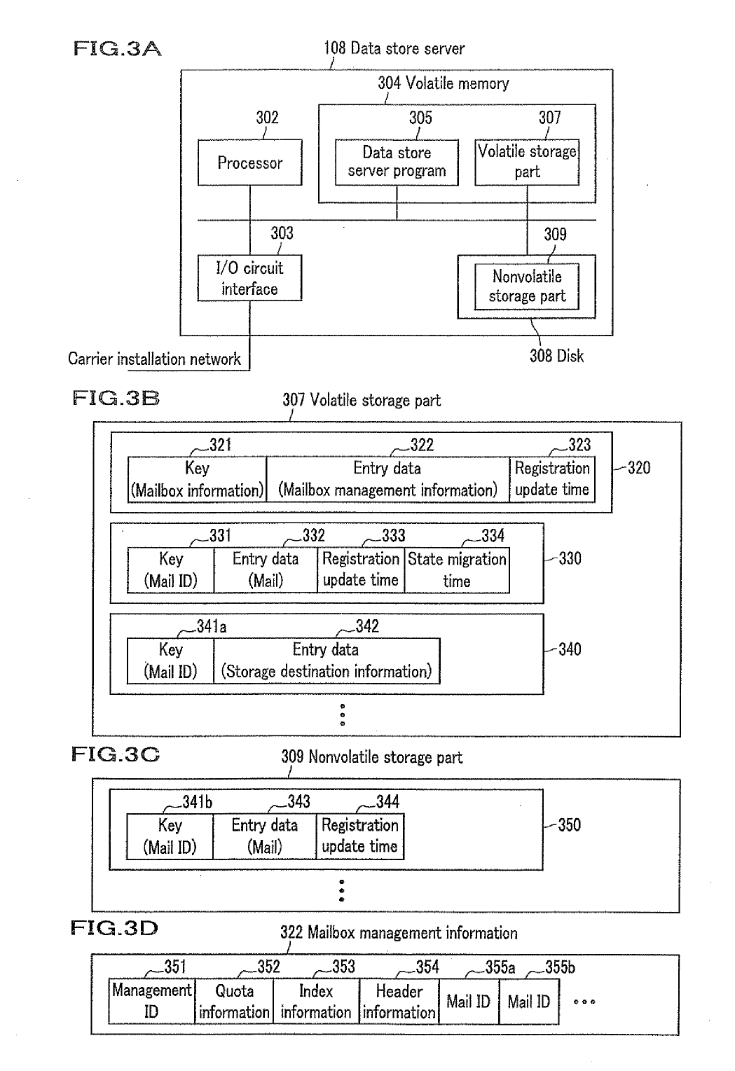

FIG. 3A and FIG. 3B are diagrams illustrating a configuration of the data store server 108 according to this embodiment. FIG. 3A is a diagram illustrating an outline of the configuration of the data store server 108 according to this embodiment.

The data store server 108 includes a processor 302, an I/O circuit interface, a volatile memory 304, and a disk 308. Those components are coupled with each other via a bus.

The processor 302 executes a data store server program 305 to be described hereinafter and stored in the volatile memory 304 and controls the data store server 108. The I/O circuit interface 203 mediates transfer of information with an I/O circuit interface of other device.

The volatile memory 304 stores therein a data or a program for execution used by the data store server 108. The volatile memory 304 includes a data store server program 305 and a volatile storage part 307.

The data store server program 305 stores therein various programs for controlling the data store server 108 (to be described in detail hereinafter). Note that those programs may be loaded in the data store server program 305 via a detachable storage medium or a communication medium (a network, a digital signal, a carrier wave, or the like) both not shown.

The volatile storage part 307 stores therein mailbox information 320 and mail data information 330, 340 (to be described in detail hereinafter).

The disk 308 includes a nonvolatile storage part 309. The nonvolatile storage part 309 stores therein mail data information 350 (to be described in detail hereinafter).

FIG. 3B is a diagram illustrating a configuration of the volatile storage part 307.

The data store server 108 is a key value store. The mailbox information 320 and the mail data information 330 and 340 manage a data using a key and a value in pair. An entry data used in this embodiment is a data stored as a value.

The mailbox information 320 includes a key 321, an entry data 322, and a registration update time 323.

A key which uniquely identifies the mailbox information 320 is stored in the key 321. The key 321 is referenced when the mailbox server 107 accesses the data store server 108 (to be described in detail hereinafter).

Mailbox management information 322 to be described hereinafter may be specifically referred to as the entry data 322.

A time and/or a date (to be hereinafter referred to as a time and date) when the mailbox information 320 is created or updated is stored in the registration update time 323.

The mail data information 330, 340 is each a data for storing a single mail. The mail data information 330 is a data format used when a mail is stored in the volatile storage part 307. The mail data information 340 has a data format used when a mail is stored in the nonvolatile storage part 309. The mail data information 340 is paired with the mail data information 350 to be described hereinafter (see FIG. 3C) and stores a mail in the nonvolatile storage part 309.

The mail data information 330 includes a key 331, an entry data 332, a registration update time 333, and a state transition time 334.

A key which uniquely identifies the mail data information 330 is stored in the key 331. As described above, because the mail data information 330 is a data for storing a single mail, the key 331 stores therein a key for uniquely identifying a mail (to be referred to as a mail ID). The mail data information 330 is referenced when the mailbox server 107 accesses the data store server 108 (to be described in detail hereinafter).

A mail is stored in the entry data 332.

A time and date when the mail data information 330 is created or updated is stored in the registration update time 333.

A time period during which a mail is migrated from the volatile storage part 307 to the nonvolatile storage part 309 (to be described in detail hereinafter) is stored in the state transition time 334. More specifically, a time having the registration update time 333 as a start time is stored in the state transition time 334.

The mail data information 340 includes a key 341a and an entry data 342.

A key for uniquely identifying the mail data information 340 is stored in the key 341a. As described above, the mail data information 340 is a data for storing therein a single mail, a mail ID is stored in the key 341. The key 341a associates the mail data information 340 with the mail data information 350 (see FIG. 3C).

Storage destination information of a mail when the mail is stored in the nonvolatile storage part 309 is stored in the entry data 342. The storage destination information to be described hereinafter may be specifically referred to as the entry data 342.

FIG. 3C is a diagram illustrating a configuration of the mail data information 350.

The mail data information 350 includes a key 341b, an entry data 343, and a registration update time 344.

A key which uniquely identifies the mail data information 350 is stored in the key 341b. As described above, the mail data information 350 stores a mail in the nonvolatile storage part 309, making a pair with the mail data information 340. At this time, the mail data information 340 and the mail data information 350 are associated with each other by the key 341b. Similarly to the key 341a, a mail ID is stored in the key 341b.

A mail is stored in the entry data 343.

A time and date when the mail data information 350 is created or updated is stored in the registration update time 344.

FIG. 3D is a diagram illustrating a configuration of the mailbox management information 322 stored in the entry data 322.

The mailbox management information 322 (which may be specifically referred to as the entry data 322) includes a management ID 351, quota information 352, index information 353, header information 354, and a mail ID 355 (which may be individually referred to as mail IDs 355a, 355b).

The management ID 351 includes a key which uniquely identifies a mailbox. More specifically, the management ID 351 stores therein, for example, a phone number or the like of the communication terminal 101.

Information on a capacity of a mailbox is stored in the quota information 352. the quota information 352 includes, for example, an entire capacity of the mailbox, a capacity in use, a usable capacity (a remaining capacity), the total number of mails storable in the mailbox, the number of mails currently stored in the mailbox, the number of mails currently storable in the mailbox (a remaining number of mails), and the like.

Information for a high-speed processing of searching a mail stored in a mailbox identified by the management ID 351 or the like is stored in the index information 353. The information for a high-speed processing of searching a mail or the like means, for example, a keyword contained in a mail text. A search of a mail using a keyword can be performed at a higher speed than a full-text search of a mail text.

Information on a mail stored in a mailbox identified by the management ID 351 is stored in the header information 354. More specifically, the header information 354 includes, for example, flag information on a mail, size information, information on a storage destination, information on access authority, information on setting of transmitting and receiving a mail, and the like.

The flag information used herein means information indicating whether a mail has been already read or remains unread, information indicating a deletion state (a state in which a mail is to be deleted at a prescribed timing), and information indicating a significance of a mail. The size information herein means information on each size of a mail and a mail header thereof. The information on a storage destination herein means information on whether a mail is stored in the volatile storage part 307 or in the nonvolatile storage part 309. The information on access authority used herein means information on whether or not a mail is usable (readable, writable, or the like).

A mail ID stored in a mailbox identified by the management ID 351 is stored in the mail ID 355 (355a, 355b). As shown in FIG. 3D, a plurality of mail IDs can be stored in the mail ID 355.

### <Configuration of Data>

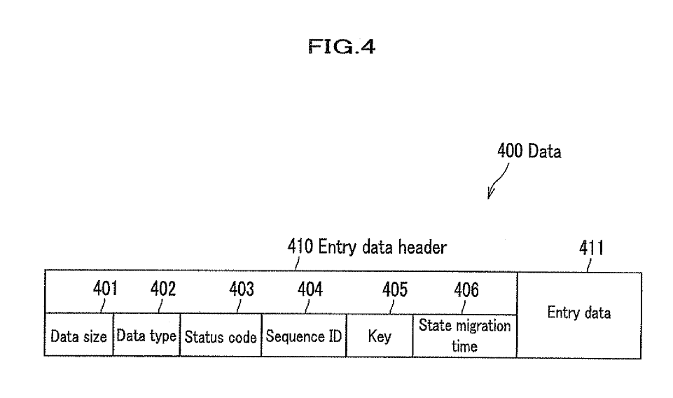

FIG. 4 is a diagram illustrating a configuration of a data 400 transferred between the mailbox server 107 and the data store server 108.

The data 400 includes an entry data header 410 and an entry data 411.

The entry data header 410 includes information on the data 400. More specifically, the entry data header 410 includes a data size 401, a data type 402, a status code 403, a sequence ID 404, a key 405, and a state transition time 406.

A data size of the entire data 400 is stored in the data size 401. Or, a data size of the entry data 411 may be stored in the data size 401.

Information on which use application the data 400 has is stored in the data type 402. The data type 402 is referenced when the data store server 108 determines how the data 400 is processed (use application). In the data type 402, stored is, for example, information indicating “request” or “response”, information indicating “storage”, “acquisition”, “update” and “deletion” of the entry data 411 (which may also be referred to as command information), information indicating a storage destination of a mail which is determined in a mail storage destination determination processing to be described hereinafter.

The “request” used in the data type 402 means a transmission of the data 400 from the mailbox server 107 to the data store server 108. Meanwhile, the “response” used in the data type 402 means a transmission of the data 400 from the data store server 108 to the mailbox server 107.

Information on details of a processing is stored in the status code 403 if the data type 402 is “response”. For example, “200 (successful completion)”, “500 (error)”, or the like is stored in the status code 403. If the data type 402 is “request”, “0” is stored in the status code 403 because the status code 403 is not used.

Information for identifying a transfer of the data 400 between the mailbox server 107 and the data store server 108 is stored in the sequence ID 404. Each time the mailbox server 107 transmits the data 400 to the data store server 108, the sequence ID 404 having a different value is issued and the different value is stored in the sequence ID 404. In the sequence ID 404, a request and a response thereto take the same values.

Information for identifying a data targeted as request or response is stored in the key 405. Any one of a key 321, a key 331, and a key 341 (see FIG. 3B) is stored in the key 405.

A time period during which a mail is migrated from the volatile storage part 307 to the nonvolatile storage part 309 is stored in the state transition time 406, similarly to the state transition time 334 (see FIG. 3B). Note that, if the state transition time 406 takes a negative value, it means that the mail is stored in the nonvolatile storage part 309 without being migrated.

A value associated with the key 405 is stored in the entry data 411. More specifically, anyone of the entry data (mailbox management information) 322, the entry data 332 (mail), the entry data 342, and the entry data 343 (mail) (see FIG. 3B) is stored in the entry data 411.

### <Mail Storage Processing>

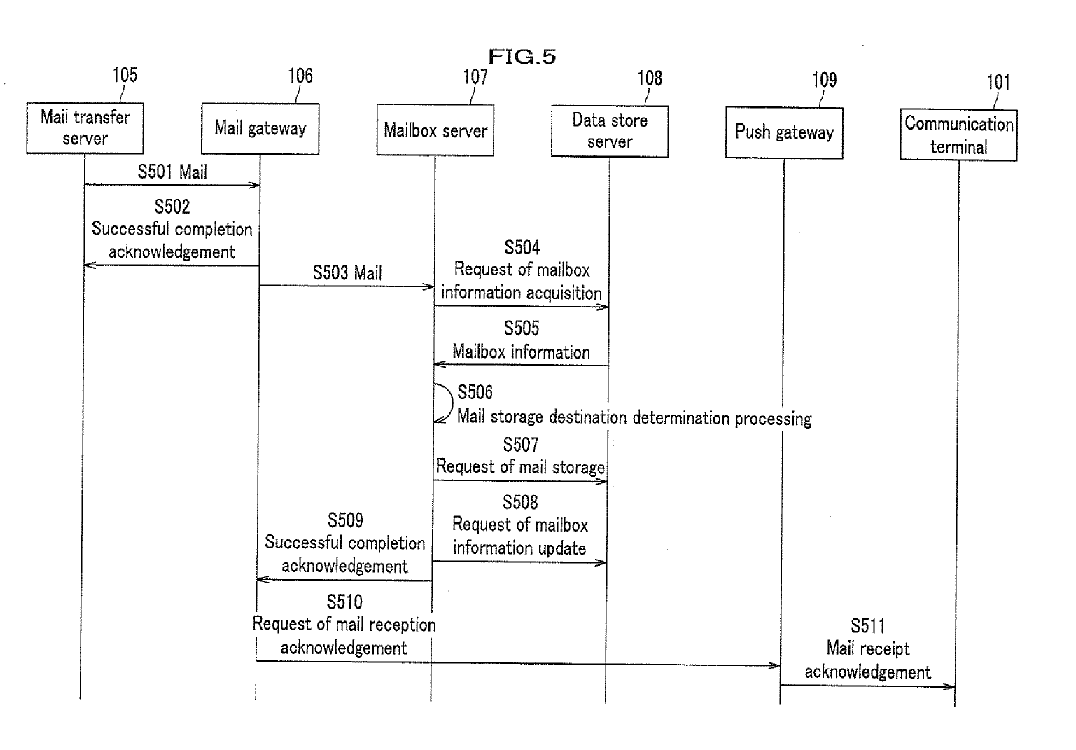

FIG. 5 is a sequence diagram illustrating a mail storage processing according to this embodiment. FIG. 5 illustrates an example in which a processing by the data store server 108 is successfully completed. For simplification, description of a case is omitted herefrom in which a response has only the entry data header 410 and lacks the entry data 411, but is successfully transmitted from the data store server 108 (such as responses in step S507 and step S508). The mailbox server 107 determines that a request is completed by receipt of a successful response.

The mail storage processing is a processing in which the mailbox server 107 receives a mail from the mail transfer server 105 via the mail gateway 106 and stores the mail in the data store server 108. The processing is performed at a timing when a user of the communication terminal 101 as a mail source not shown operates the communication terminal 101 and thereby transmits a mail.

The mail transfer server 105 transmits a mail to the mail gateway 106 (step S501).

The mail gateway 106 converts a data format of the mail received from the mail transfer server 105 or the like to make the mail transmittable to the mailbox server 107. If the mail becomes transmittable, the mail gateway 106 acknowledges a successful completion to the mail transfer server 105 (step S502).

The mail gateway 106 transmits the mail received from the mail transfer server 105, to the mailbox server 107 (step S503).

The mailbox server 107 requests the data store server 108 to acquire the mailbox information 320 (see FIG. 3B) corresponding to a destination of the mail received from the mail gateway 106 (step S504). The destination of the mail used herein means, for example, a phone number or the like of the communication terminal 101 and is stored in the management ID 351 shown in FIG. 3D.

How the mailbox information 320 associated with the destination of a mail is identified varies according to a mail system of a mobile communication carrier or a specification of the communication terminal 101.

In this case, values as follows are stored in the data 400 (see FIG. 4) transmitted from the mailbox server 107 to the data store server 108.

A data size of the entire data 400 is stored in the data size 401.

Information indicating request, and command information indicating acquisition of the entry data 411 (which may also be referred to as the mailbox management information 322) is stored in the data type 402.

The status code 403 is not used.

A value which is, for example, numbered sequentially and is obtained by adding 1 (one) to a previously-issued sequence ID 404 is stored in the sequence ID 404.

Information for identifying the mailbox information 320 (the key 321) associated with a destination of the mail is stored in the key 405.

The state transition time 406 is not used.

The entry data 411 is not used.

The data store server 108 transmits the mailbox information 320 corresponding to a request from the mailbox server 107, to the mailbox server 107 (step S505). More specifically, the data store server 108 searches the key 321 using the key 405 contained in the request from the mailbox server 107 as a search key, to thereby enable to identify (acquire) the mailbox information 320 corresponding to the request.

In this case, values as follows are stored in the data 400 (see FIG. 4) transmitted from the data store server 108 to the mailbox server 107.

A data size of the entire data 400 is stored in the data size 401.

Information indicating response is stored in the data type 402.

“200 (successful completion)” is stored in the status code 403, if the data store server 108 has successfully acquired the mailbox information 320. If not, a value other than that indicating “successfully completed”, such as “500 (error)” is stored in the status code 403.

A value issued by the mailbox server 107 in step S504 is stored in the sequence ID 404. This makes it clear that the data 400 is a response to the request in step S504. Information for identifying the mailbox information 320 (the key 321) associated with a destination of the mail is stored in the key 405.

The state transition time 406 is not used.

The acquired mailbox information 320 is stored in the entry data 411. However, if the mailbox information 320 could not be acquired, the entry data 411 is not used.

The mailbox server 107 performs a mail storage destination determination processing based on the mailbox information 320 or the like received from the data store server 108 (step S506).

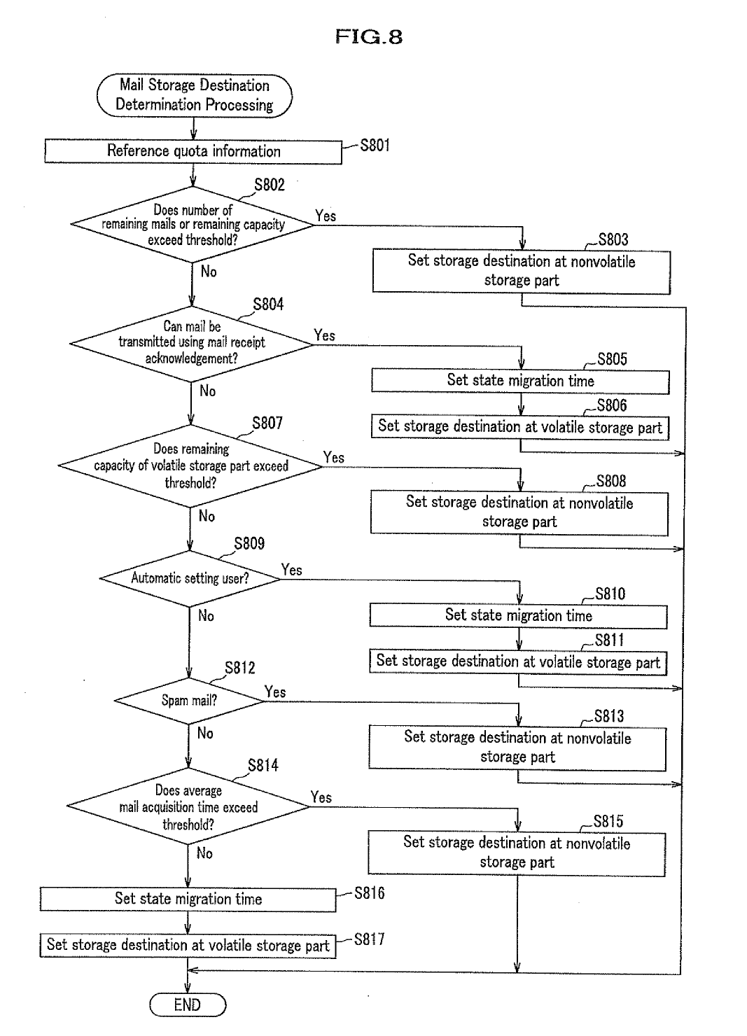

The mail storage destination determination processing is a processing of determining whether the mail received from the mail gateway 106 in step S503 is stored in the volatile storage part 307 or in the nonvolatile storage part 309. Details of the mail storage destination determination processing will be described hereinafter with reference to FIG. 8.

The mailbox server 107 requests the data store server 108 to store the mail based on a result of the mail storage destination determination processing (step S507).

In this case, values as follows are stored in the data 400 (see FIG. 4) transmitted from the mailbox server 107 to the data store server 108.

A data size of the entire data 400 is stored in the data size 401.

Information indicating request, command information indicating storage of the entry data 411 (the mail received from the mail gateway 106 in step S503), and information indicating the mail destination determined in the mail storage destination determination processing (see FIG. 8) are stored in the data type 402.

The status code 403 is not used.

A value which is, for example, numbered sequentially and is obtained by adding 1 (one) to a value previously issued by the mailbox server 107 in step S504 is stored in the sequence ID 404.

A mail ID of the mail received from the mail gateway 106 in step S503 is stored in the key 405.

A value set in the mail storage destination determination processing (see FIG. 8) is stored in the state transition time 406.

The mail received from the mail gateway 106 in step S503 is stored in the entry data 411.

The data store server 108 stores the mail in the volatile storage part 307 or the nonvolatile storage part 309 based on the data 400 received from the mailbox server 107.

More specifically, if the data type 402 contains information showing that a storage destination of the mail is the nonvolatile storage part 309, the data store server 108 stores the mail in the nonvolatile storage part 309 (see FIG. 3A and FIG. 3C).

At this time, the key 405 is stored in both of the key 341a and the key 341b.

Information showing a storage destination of the mail is stored in the entry data 342. More specifically, the entry data 342 is, for example, an address or the like of the nonvolatile storage part 309.

The entry data 411 is stored in the entry data 343.

A current time and date is stored in the registration update time 344.

On the other hand, if the data type 402 contains information showing that the storage destination of the mail is the volatile storage part 307, the data store server 108 stores the mail in the volatile storage part 307 (see FIG. 3A, FIG. 3B, and FIG. 3D).

At this time, the key 405 is stored in the key 331.

The entry data 411 is stored in the entry data 332.

A current time and date is stored in the registration update time 333.

The state transition time 406 is stored in the state transition time 334.

The mailbox server 107 requests the data store server 108 to update the mailbox information 320 (see FIG. 3B and FIG. 3D) (step S508). More specifically, in step S508, the mailbox server 107 requests the data store server 108 to store (or update) information on the mail stored in step S507, in the mailbox information 320 identified in step S505.

The data store server 108 updates the mailbox information 320 (see FIG. 3B and FIG. 3D). At this time, updated items of the mailbox information 320 are as follows.

A current time and date is stored in the registration update time 323.

Respective values reflecting information relevant to the stored mail are stored in the quota information 352, the index information 353, and the header information 354.

The key 405 is stored in (added to) the mail ID 355.

If the mail storage and the update of the mailbox information 320 are successfully completed, the mailbox server 107 acknowledges a successful completion to the mail transfer server 105 (step S509).

The mail gateway 106 transmits a request of a mail receipt acknowledgement to the push gateway 109 (step S510). The mail receipt acknowledgement used herein means an acknowledgement indicating that a mail has been received in a mailbox. The mail receipt acknowledgement may include the mail. The mail receipt acknowledgement request means a request for transmitting a mail receipt acknowledgement.

Generally, PAP (Push Access Protocol) is used as a communication protocol for a mail receipt acknowledgement request, and SMPP (Short Message Peer-to-Peer Protocol), for the mail receipt acknowledgement. In this embodiment, however, the communication protocols used are not limited.

The push gateway 109 transmits a mail receipt acknowledgement to the communication terminal 101 in response to the mail receipt acknowledgement request from the mail gateway 106 (step S511).

### <Outline of Mail Receipt Processing>

Next is described a processing of receiving a mail by the communication terminal 101. The processing of receiving (acquiring) a mail by the communication terminal 101 is divided into 3 types as follows.

1) Upon receipt of a mail receipt acknowledgement (see step S511 (FIG. 5)), the communication terminal 101 automatically accesses a mailbox and acquires a mail, which is hereinafter referred to as Type 1.
2) A user of the communication terminal 101 operates the communication terminal 101 and thereby acquires a mail, which is hereinafter referred to as Type 2.
3) The communication terminal 101 acquires a mail in such a way that the mail is included in the mail receipt acknowledgement (see step S511 (FIG. 5)) or in a message in other communication protocol, which is hereinafter referred to as Type 3.

In Type 1, after receiving the mail receipt acknowledgement, the communication terminal 101 acquires or deletes a mail in a mailbox. Thus, a time period during which the mailbox holds the mail is short.

In Type 2, upon the user's operation of the communication terminal 101, a mail in a mailbox is acquired or deleted. Thus, the time period during which the mailbox holds the mail can be long depending on timing of the user's operation.

In Type 3, the communication terminal 101 receives a mail using the mail receipt acknowledgement. Thus, a processing of acquiring a mail is not necessary.

In 3 types described above, the time period during which the mailbox holds the mail means a time period during which the data store server 108 stores the mail in the volatile storage part 307. If a remaining capacity of the volatile storage part 307 becomes small, the data store server 108 stores (moves) the mail into the nonvolatile storage part 309. A speed of processing the mail is slowed down and a mail throughput is also reduced, because the mail is stored in the nonvolatile storage part 309 having a lower processing speed than the volatile storage part 307.

The mail storage destination determination processing (see step S506 (FIG. 5)) makes it possible to store a mail in a storage destination suited to each type. Thus, the number of mails stored in the volatile storage part 307 is increased and a mail throughput is improved. Next is described each of the types.

### <Mail Receipt Processing of Type 1>

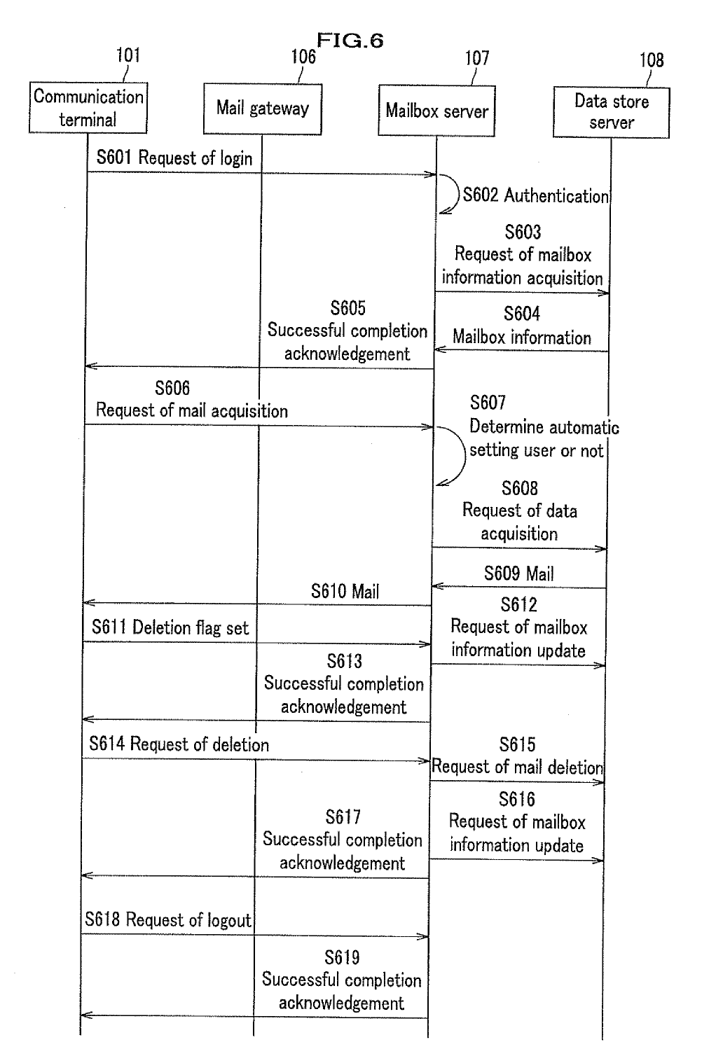

First is described the mail receipt processing of Type 1. FIG. 6 is a sequence diagram illustrating a mail receipt processing in a case in which the communication terminal 101 automatically acquires a mail. FIG. 6 illustrates an example in which a processing performed by the data store server 108 is successfully completed. For simplification, description of a successful response transmitted from the data store server 108 without the entry data 411 (responses in step S612, step S615, and step S616) is omitted herefrom. Receipt of the successful response makes the mailbox server 107 determine that the request has been completed.

The mail receipt processing is performed upon receipt of a mail receipt acknowledgement by the communication terminal 101 (see step S511 (FIG. 5)). Note that, in the processing, a communication between the communication terminal 101 and the mailbox server 107 is actually performed via a relay operation by the mail gateway 106. Description of the mail gateway 106 is, however, omitted herefrom.

The communication terminal 101 requests the mailbox server 107 to login thereinto (step S601).

The mailbox server 107 authenticates whether or not the login is allowed in response to the request from the communication terminal 101 (step S602).

If the login is allowed as a result of the authentication in step S602, the mailbox server 107 requests the data store server 108 to acquire the mailbox information 320 (see FIG. 3B) (step S603).

In this case, the data 400 (see FIG. 4) transmitted from the mailbox server 107 to the data store server 108 is similar to the data 400 in step S504 (see FIG. 5). Note that information (key 321) for identifying the mailbox information 320 associated with the communication terminal 101 is stored in the key 405.

How to identify the mailbox information 320 associated with the communication terminal 101 varies according to a mail system of a mobile communication carrier or a specification of the communication terminal 101. See below, for example.

1) Information (key 321) for uniquely identifying the mailbox information 320 is also transmitted at the time of the login request in step S601. The mailbox information 320 is identified based on the information.
2) The mailbox server 107 holds information for associating the information for uniquely identifying the communication terminal 101, together with the information (key 321) for uniquely identifying the mailbox information 320. The mailbox information 320 is identified based on the both information at the time of the authentication in step S602.

The data store server 108 transmits the mailbox information 320 corresponding to the mailbox acquisition request in step S603, to the mailbox server 107 (step S604).

In this case, the data 400 (see FIG. 4) transmitted from the data store server 108 to the mailbox server 107 is similar to the data 400 in step S505 (see FIG. 5). Note that the information (the key 321) for identifying the mailbox information 320 associated with the communication terminal 101 is stored in the key 405.

In step S604, if the mailbox server 107 has successfully acquired the mailbox information 320, the mailbox server 107 acknowledges to the communication terminal 101 that the login request in step S601 has been successfully completed (step S605).

The communication terminal 101 transmits a mail transmit request to the mailbox server 107 (step S606).

The mailbox server 107 determines whether or not the communication terminal 101 is set to acquire a mail with the processing of Type 1, based on the mail acquisition request from the communication terminal 101 in step S606 (step S607). A user of the communication terminal 101 in which a mail is acquired with Type 1 is hereinafter referred to as an automatic setting user.

How to determine whether or not a user is an automatic setting user varies according to a mail system of a mobile communication carrier or a specification of the communication terminal 101. See below, for example.

1) A mail acquisition request contains information showing that the communication terminal 101 is set to acquire a mail with Type 1 as described above. The determination is made based on the information.
2) The determination is made based on a sequence of the steps from the login request in step S601 to the mail acquisition request in step S606.

The mailbox server 107 transmits a mail acquisition request to the data store server 108 (step S608).

In this case, values as follows are stored in the data 400 (see FIG. 4) transmitted from the mailbox server 107 to the data store server 108.

A data size of the entire data 400 is stored in the data size 401.

Information indicating request and the command information indicating acquisition of the entry data 411 (the entry data 332) is stored in the data type 402.

The status code 403 is not used.

A value which is, for example, numbered sequentially and is obtained by adding 1 (one) to the previously-issued sequence ID 404 is stored in the sequence ID 404.

A mail ID is stored in the key 405.

The state transition time 406 is not used.

The entry data 411 is not used.

The mail ID stored in the key 405 can be specified based on the mailbox information 320 acquired step S604. For example, if information (flag information) indicating “unread” is stored in the header information 354, an appropriate mail ID indicating “unread” is stored in the key 405.

The data store server 108 transmits the mail specified by the mail acquisition request from the mailbox server 107 in step S608, to the mailbox server 107 (step S609).

Herein, the specified mail is stored in the volatile storage part 307 (see FIG. 3A) of the data store server 108, by the mail storage destination determination processing (to be described in detail hereinafter, see step S506 (FIG. 5) and steps S809 to S811 (FIG. 8)). The data store server 108 identifies the mail data information 330 (see FIG. 3B) which stores the key 331 identical to the mail ID specified by the mail acquisition request. The data store server 108 then transmits the entry data 332 of the identified mail data information 330 to the mailbox server 107.

In this case, values as follows are stored in the data 400 (see FIG. 4) transmitted from the data store server 108 to the mailbox server 107.

A data size of the entire data 400 is stored in the data size 401.

Information indicating response is stored in the data type 402.

If the data store server 108 has successfully acquired the entry data 332, “200” (successful completion) is stored in the status code 403. If not, a value other than the value indicating the successful completion, such as “500” (error) is stored in the status code 403.

A value issued by the mailbox server 107 in step S608 is stored in the sequence ID 404.

A mail ID is stored in the key 405.

The state transition time 406 is not used.

If the entry data 332 has been successfully acquired, the acquired entry data 332 is stored in the entry data 411. If not, the entry data 411 is not used.

The mailbox server 107 rewrites a mail header or the like of the mail received from the data store server 108 in step S609 and transmits the mail to the communication terminal 101 (step S610).

Upon receipt of the mail from the mailbox server 107, the communication terminal 101 transmits a deletion flag set to the mailbox server 107 (step S611). The deletion flag set used herein means a request that a mail stored in a mailbox be in a deletion state. More specifically, the deletion flag set means, for example, transmission of a request to set a delete flag with a store command in IMAP.

The mailbox server 107 requests the data store server 108 to update the mailbox information 320 (see FIG. 3B and FIG. 3D) (step S612). In step S612, the mailbox server 107 requests the data store server 108 to put the mail received from the data store server 108 in step S609, into a deletion state. More specifically, the mailbox server 107 requests the data store server 108 to store information indicating the deletion state, in the header information 354 (see FIG. 3D) of the mailbox information 320 in which a mail ID of the mail is stored.

Upon update of the mailbox information 320 by the data store server 108, the mailbox server 107 acknowledges the communication terminal 101 that the update of the mailbox information 320 has been successfully completed (step S613).

The communication terminal 101 transmits a deletion request to the mailbox server 107 (step S614). The deletion request used herein means a request to delete a mail. More specifically, the deletion request means Expunge request in IMAP.

The mailbox server 107 transmits a request for deleting the mail which is specified by the deletion request from the communication terminal 101 in step S614, to the data store server 108 (step S615). Note that the mail deletion request contains a mail ID of the mail to which the request is targeted. More specifically, the mailbox server 107 requests the data store server 108 to delete the mail data information 330 (see FIG. 3B) in which the mail received from the data store server 108 is stored in step S609.

The mailbox server 107 requests the data store server 108 to update the mailbox information 320 (step S616). In step S616, the mailbox server 107 requests the data store server 108 to delete the mail received from the data store server 108 in step S609. More specifically, the mailbox server 107 requests the data store server 108 to delete a mail ID or the like of the mail from the mailbox information 320 (see FIG. 3B and FIG. 3D) in which the mail is stored.

Upon deletion of the mailbox information 320 and update of the mailbox information 320 by the data store server 108, the mailbox server 107 acknowledges the communication terminal 101 that the deletion of the mail and the update of the mailbox information 320 have been successfully completed (step S617).

The communication terminal 101 transmits a logout request to the mailbox server 107 (step S618).

The mailbox server 107 acknowledges the communication terminal 101 that the logout has been successfully completed (step S619).

As described above, the mail receipt processing of Type 1 is performed upon receipt of a mail receipt acknowledgement by the communication terminal 101 (see step S511 of FIG. 5). A time period from when the data store server 108 stores a mail (step S507) until when the data store server 108 deletes the mail (step S615) is therefore short. This makes less negative effect on a capacity of the volatile storage part 307 even if the mail is stored therein. Thus, the mail storage destination determination processing (step S506) determines the volatile storage part 307 as a storage destination of the mail.

### <Mail Receipt Processing of Type 2>

Next is described a mail receipt processing of Type 2.

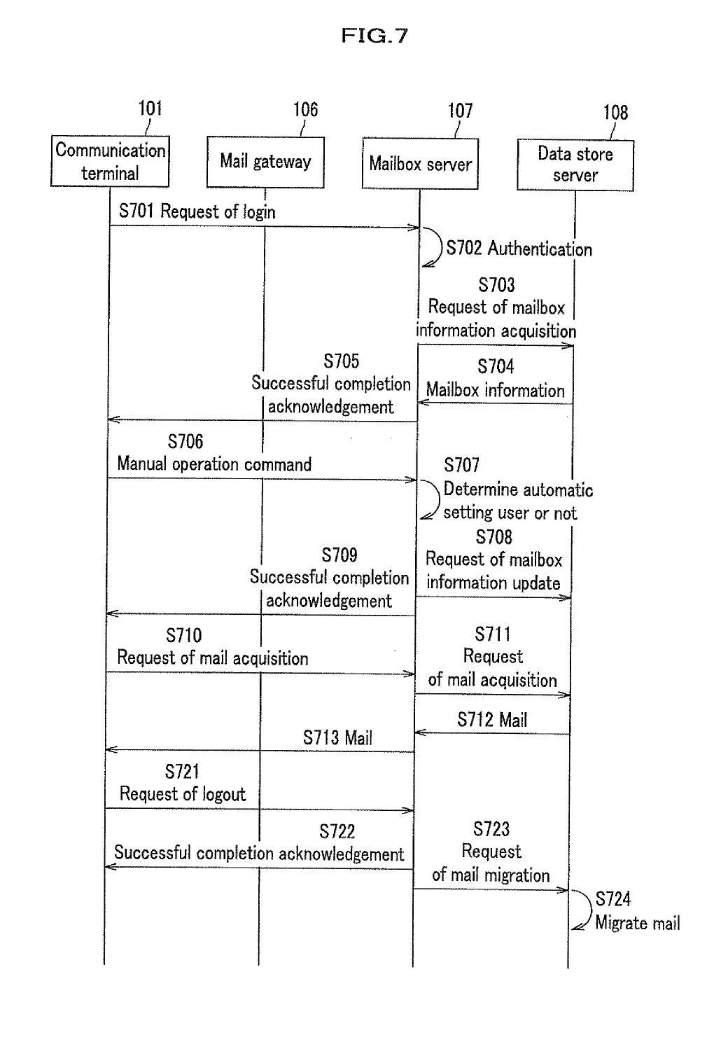

FIG. 7 is a sequence diagram illustrating a mail receipt processing in a case in which a user of the communication terminal 101 operates the communication terminal 101 to thereby acquire a mail. FIG. 7 illustrates an example in which the processing by the data store server 108 is successfully completed. For simplification, description of a case is omitted herefrom in which a response is successfully transmitted from the data store server 108 but the data 400 in the response only contains the entry data header 410 and lacks the entry data 411 (such as responses in step S708 and step S723). Receipt of the successful response makes the mailbox server 107 determine that the request has been completed.

The mail receipt processing shown in FIG. 7 is performed upon operation of the communication terminal 101 by a user thereof. In the processing, a communication between the communication terminal 101 and the mailbox server 107 is actually performed via the mail gateway 106. However, description of the mail gateway 106 is omitted herefrom.

Note that a duplicate description of the processing similar to that shown in FIG. 6 is omitted herefrom.

Steps S701 to S705 are performed similarly to steps S601 to S605 shown in FIG. 6.

The communication terminal 101 then transmits a manual operation command to the mailbox server 107 (step S706). The manual operation command used herein means a command which is transmitted from the communication terminal 101 by operating the communication terminal 101 by a user thereof. The manual operation command includes, for example, a command to acquire information on a size, a header, or the like of a mail, a command to set a specific flag at a mail, and the like.

The mailbox server 107 determines whether or not the communication terminal 101 is set to acquire a mail with the method of Type 2, based on the mail acquisition request from the communication terminal 101 in step S706 (step S707). A user of the communication terminal 101 which is set to acquire a mail by the processing of Type 2 is hereinafter referred to as a manual setting user.

Whether or not a user is a manual setting user is determined based on the mailbox information 320 received by the mailbox server 107 from the data store server 108 in step S704. As described above, the header information 354 (see FIG. 3B and FIG. 3D) of the mailbox information 320 contains the setting information on transmission and receipt of a mail. If information indicating that a user is a manual operation user is stored in the header information 354, the mailbox server 107 determines that the user of the communication terminal 101 is a manual operation user.

Whether or not a user is a manual setting user can also be determined based on the manual operation command received by the mailbox server 107 from the communication terminal 101 in step S706. If the manual operation command contains information indicating that the user is a manual setting user, the communication terminal 101 determines that the user of the communication terminal 101 is a manual setting user.

The mailbox server 107 requests the data store server 108 to update the mailbox information 320 (step S708). That is, in step S708, the mailbox server 107 requests the data store server 108 to update the mailbox information 320 specified in step S704. More specifically, the mailbox server 107 requests the data store server 108 to store information showing that the user is a manual setting user, in the header information 354 (see FIG. 3D) of the mailbox information 320.

Upon update of the mailbox information 320 by the data store server 108, the mailbox server 107 acknowledges the communication terminal 101 that the update of the mailbox information 320 has been successfully completed (step S709).

Steps S710 to S713 are performed similarly to steps S606 to S610 shown in FIG. 6.

As described above, steps S701 to S713 constitute the processing of acquiring a mail by operating the communication terminal 101 by a user thereof. Below are described steps S721 to S724 which constitute a processing in a case in which the user logs out without deleting the acquired mail.

Steps S721 to S722 are performed similarly to steps S618 to S619 shown in FIG. 6.

The mailbox server 107 transmits a mail transition request to the data store server 108 (step S723).

The mail transition request used herein means a request to migrate a mail from the volatile storage part 307 to the nonvolatile storage part 309 (see FIG. 3A). More specifically, the mailbox server 107 stores the mail received from the data store server 108 in step S712 and stored in the volatile storage part 307, in the nonvolatile storage part 309.

Further specifically, as described above, the mail data information 340 and the mail data information 350 (see FIG. 3C) are created based on the mail data information 330 (see FIG. 3B) and are stored in the volatile storage part 307 and the nonvolatile storage part 309, respectively. At this time, the key 331 is stored in the key 341; information indicating a storage destination of the mail data information 350, in the entry data 342; the entry data 332, in the entry data 343; and a time when the mail data information 350 is created, in the registration update time 344.

In response to the mail transition request from the mailbox server 107, the data store server 108 migrates a mail corresponding to the request, from the volatile storage part 307 to the nonvolatile storage part 309.

Herein, the data store server 108 may delete the mail in response to the mail deletion request (step S615 (see FIG. 6)), instead of the mail transition request.

As described above, the mail receipt processing of Type 2 is performed upon operation of the communication terminal 101 by a user thereof. A time period from when the data store server 108 stores a mail (step S507 (see FIG. 5)) to when the data store server 108 migrates or deletes the mail (step S615 (see FIG. 6)) therefore depends on an operation by the user. If a mail is stored in the volatile storage part 307 without being migrated or deleted, a capacity of the volatile storage part 307 may be negatively affected. Thus, in the mail storage destination determination processing (step S506 (see FIG. 5)), a storage destination of a mail is determined based on an average mail acquisition time or the like to be hereinafter described.

### <Mail Receipt Processing of Type 3>

Finally is described a mail receipt processing of Type 3.

In the mail receipt processing of this type, a mail is contained in a mail receipt acknowledgement and is transmitted to the communication terminal 101. This eliminates a need of another processing of acquiring a mail by the communication terminal 101.

A mail having already been transmitted to the communication terminal 101 can be deleted by transmitting a mail deletion request (similarly to step S615 (FIG. 6)). Such a mail can be deleted:

1) after a response (not shown) to a mail receipt acknowledgement; or
2) after the communication terminal 101 automatically login to the mailbox server 107 (similarly to step S601 (see FIG. 6)).

As described above, the mail receipt processing of Type 3 requires a short time from when the data store server 108 stores therein a mail (step S507 (see FIG. 5)) until when the data store server 108 deletes the mail. This makes less negative effect on a capacity of the volatile storage part 307, even if the mail is stored in the volatile storage part 307. Thus, in the mail storage destination determination processing (step S506 (see FIG. 5)), the mail is determined to be stored in the volatile storage part 307.

### <Mil Storage Destination Determination Processing>

Next is described a mail storage destination determination processing.

FIG. 8 is a flowchart of the mail storage destination determination processing (see step S506 (FIG. 5)). The mail storage destination determination processing is a processing performed by the mailbox server program 205 (see FIG. 2A) based on the data 400 (see FIG. 4) or the like transmitted from the data store server 108 to the mailbox server 107 in step S505.

In step S801, the mailbox server program 205 references the quota information 352 (see FIG. 3D) of the mailbox information 320 (see FIG. 3B) stored in the entry data 411. The processing then advances to step S802.

In step S802, the mailbox server program 205 determines whether or not the number of remaining mails or a remaining capacity exceeds each threshold stored in the quota information 352.

If either the number of remaining mails or the remaining capacity exceeds each threshold (if “Yes” in step S802), the processing advances to step S803. In this case, the reason may be one of:

1) a user is a manual setting user and has not performed an operation for acquiring a mail; 2) the communication terminal 101 is powered off or is out of service of the wireless network 102; and 3) a user has made a setting of acquiring no mail because the user is out of the country or the like. Thus, it takes a long time for the communication terminal 101 to receive a mail.

If neither the number of remaining mails nor remaining capacity exceeds each threshold (if “No” in step S802), the processing advances to step S804.

In step S803, the mailbox server program 205 sets a storage destination of the mail at the nonvolatile storage part 309. More specifically, the mailbox server program 205 stores the nonvolatile storage part 309 as information indicating the storage destination of the mail, in the data type 402. Alternatively, the mailbox server program 205 sets a negative value at the state transition time 406. The processing then returns to step S506.

In step S804, the mailbox server program 205 determines whether or not a mail can be transmitted using a mail receipt acknowledgement. If the mail can be transmitted (if “Yes” in step S804), the processing advances to step S805. If not (if “No” in step S804), the processing advances to step S807.

Whether or not a mail is transmittable using a mail receipt acknowledgement can be determined based on, for example, a size of the mail. If the mail size is smaller than a prescribed threshold, the mailbox server program 205 can determine that the mail is transmittable. If the mail size is equal to or more than the prescribed threshold, the mailbox server program 205 can determine that the mail is transmittable. Further, if a small-sized mail is stored in the volatile storage part 307 to thereby perform a high-speed processing of a large number of mails, a mail throughput is improved.

In step S805, the mailbox server program 205 sets the state transition time 406. A predetermined value may be set at the state transition time 406. Alternatively, a value calculated based on the number of remaining mails, a remaining capacity, or the like stored in the quota information 352 may be set at the state transition time 406. Or, a value of the key 405 or a value based on a circuit receiving the mail may be set at the state transition time 406.

The processing then advances to step S806.

In step S806, the mailbox server program 205 sets a storage destination of the mail at the volatile storage part 307. More specifically, the mailbox server program 205 stores information showing that the volatile storage part 307 is the storage destination of the mail, in the data type 402, and sets a prescribed value at the state transition time 406. The processing then returns to step S506.

In step S807, the mailbox server program 205 determines whether or not the remaining capacity of the volatile storage part 307 exceeds a threshold. More specifically, the mailbox server program 205 makes the above-described determination based on size information and storage destination information on each mail stored in the header information 354. This allows a user or users to use the volatile storage part 307 relatively equally.

If the remaining capacity exceeds the threshold (if “Yes” in step S807), the processing advances to step S808. If not (if “No” in step S807), the processing advances to step S809.

Step S808 is performed similarly to step S803.

In step S809, the mailbox server program 205 determines whether or not the user of the communication terminal 101 is an automatic setting user. More specifically, the mailbox server program 205 determines whether or not the user is an automatic setting user based on the setting information on transmission and receipt of a mail stored in the header information 354.

If the user is an automatic setting user (if “Yes” in step S809), the processing advances to step S810. If the user is not an automatic setting user (if “No” in step S809), the processing advances to step S812.

Step S810 to S811 are performed similarly to step S805 to S806.

In step S812, the mailbox server program 205 determines whether or not the received mail is a spam mail. The determination can be made using any method in the known art. If the received mail is a spam mail, the user may delete the mail without receiving. Therefore, even if the spam mail is stored in the volatile storage part 307, improvement in a mail throughput cannot be expected.

If the received mail is a spam mail (if “Yes” in step S812), the processing advances to step S813. If the received mail is not a spam mail (if “No” in step S812), the processing advances to step S814.

Step S813 is performed similarly to step S803.

In step S814, the mailbox server program 205 determines whether or not an average mail acquisition time exceeds a threshold. The average mail acquisition time used herein means an average value of time periods from when a mail is received to when the communication terminal 101 acquires the mail. Further in detail, the average mail acquisition time means an average value of time periods from when, in step S507 (see FIG. 5), the mail transmitted from the mailbox server 107 to the data store server 108 is stored by the data store server 108 in the volatile storage part 307 or the nonvolatile storage part 309, until when the mail is received by the communication terminal 101 and is deleted from the data store server 108. More specifically, the average mail acquisition time can be calculated based on the registration update time 333 in the mail data information 330 (see FIG. 3B), the registration update time 344 in the mail data information 350 (see FIG. 3C), a log stored in the disk 208 (see FIG. 2A) and outputted from the mailbox server program 205, or the like.

If the average mail acquisition time exceeds the threshold (if “Yes” in step S814), the processing advances to step S815. If the average mail acquisition time does not exceed the threshold (if “No” in step S814), the processing advances to step S816.

Step S815 is performed similarly to step S803.

Steps S816 to S817 are performed similarly to steps S805 to S806.

Note that the flowchart of FIG. 8 is shown as an example. A condition for determination, an order of determination, a state transition time to be set, or the like can be arbitrarily changed.

### ADVANTAGEOUS EFFECTS

In this embodiment, a storage destination of a mail is determined according to a feature of the mail, a feature of a mailbox (the volatile storage part 307 or the disk 308 of the data store server 108), or setting information on transmission and receipt of the mail. Thus, a larger number of such mails that are likely to be accessed by the communication terminal 101 can be stored in the volatile storage part 307.

The feature of a mail used herein includes a size of the mail (which may also be referred to as size information), flag information, information on storage destination, information on access authority, information on whether or not the mail is a spam mail, and the like.

The feature of a mailbox used herein includes an entire capacity of the mailbox, a capacity in use (a used capacity), a usable capacity (a remaining capacity), the total number of mails storable in the mailbox (the total number of storable mails), the number of mails currently stored in the mailbox (the number of stored mails), the number of mails currently storable in the mailbox (the number of remaining mails), and the like.

In this embodiment, a state transition time is set. This allows a mail not accessed by the communication terminal 101, to be migrated from the volatile storage part 307 to the nonvolatile storage part 309. Thus, the volatile storage part 307 can be used more efficiently.

As described above, a larger number of mails are stored in the volatile storage part 307 which has a higher processing speed than the nonvolatile storage part 309. Thus a mail throughput can be improved.

The specification and drawings are, accordingly, to be regarded in an illustrative rather than a restrictive sense. It will, however, be evident that various modifications and changes may be made thereto without departing from the spirit and scope of the invention(s) as set forth in the claims.

We claim:

1. A mail system comprising:
a data store server that stores therein a mail transmitted to a user of a terminal device; and
a mailbox server that controls the storage of the mail,
wherein a storage part of the data store server has a first storage part and a second storage part, and
wherein a control part of the mailbox server determines whether the mail is stored in the first storage part or in the second storage part, based on at least one of a feature of the mail, a feature of the control part of the data store server, and information on setting of the terminal device.

2. The mail system according to claim 1,
wherein the feature of the storage part of the data store server is at least one of the number of mails stored in the storage part, a size of a mail, and the information on setting of the terminal device.

3. The mail system according to claim 1,
wherein the information on setting of the terminal device is determined based on how the terminal device accesses the mail server.

4. The mail system according to claim 1,
wherein the feature of the mail is the size of the mail.

5. The mail system according to claim 4,
wherein the control part of the mailbox server determines whether the mail is stored in the first storage part or in the second storage part, further based on an average mail acquisition time which is an average value of time periods from when the mail is stored in the storage part until when the mail is deleted.

6. The mail system according to claim 5,
wherein the control part of the mailbox server determines a state transition time which is a time period during which a mail determined to be stored in the first storage part is migrated from the first storage part to the second storage part.

7. The mail system according to claim 6,
wherein the storage part of the data store server stores therein the mail based on the storage destination of the mail determined by the mailbox server or on the state transition time.
